(19) United States
(12) Patent Application Publication
(10) Pub. No.: US 2026/0169526 A1
(43) Pub. Date: Jun. 18, 2026

(54) ELECTRONIC APPARATUS

(71) Applicant: LENOVO JAPAN LLC, YOKOHAMA (JP)

(72) Inventors: Makoto Hashikura, YOKOHAMA (JP); Fumitake Mizoguchi, YOKOHAMA (JP)

(73) Assignee: LENOVO JAPAN LLC, YOKOHAMA (JP)

(21) Appl. No.: 19/218,475

(22) Filed: May 26, 2025

(30) Foreign Application Priority Data
Dec. 16, 2024 (JP) 2024219676

(51) Int. Cl. G06F 1/16

(52) U.S. Cl. CPC G06F 1/1635; G06F 1/1656; G06F 1/169

(57) ABSTRACT

An electronic apparatus includes: a chassis member having an inner surface; a battery device that is attachably and detachably supported on an inner surface side of the chassis member, in which the battery device includes a metal plate on one surface disposed to face the inner surface side of the chassis member, and the inner surface of the chassis member is provided with a conductive member that is in contact with the metal plate.

### BACKGROUND OF THE INVENTION

### Field of the Invention

The present invention relates to an electronic apparatus including a battery device.

### Description of the Related Art

An electronic apparatus such as a notebook PC or a tablet PC includes a chassis configured in a flat box shape and a battery device accommodated in the chassis (for example, refer to Japanese Patent No. 7309838).

### SUMMARY OF THE INVENTION

A chassis of an electronic apparatus as described above is strongly required to be thinned. Therefore, a general electronic apparatus is installed such that a battery device is embedded in a chassis to save space. That is, such an electronic apparatus is not designed to allow users to replace the batteries.

In recent years, from the viewpoint of environment, social, and governance (ESG), there is a demand for a product with excellent maintainability for the above-described electronic apparatus. From this viewpoint, it is desirable that the battery device can be easily replaced.

In a configuration in which the user is assumed to replace the battery device, it is necessary to prevent the battery device from malfunctioning during replacement. Therefore, it is also conceivable that the battery device is provided with a metal plate as a protective material, but a grounding measure therefor is a problem. This is because there is a concern that the electrical characteristics of the metal plate may affect the antenna or the like mounted in the chassis.

The present invention has been made in consideration of the above-described problems of the related art, and an object of the present invention is to provide an electronic apparatus that can ensure grounding in a replaceable battery device.

An electronic apparatus according to an aspect of the present invention includes: a chassis member having an inner surface; a battery device that is attachably and detachably supported on an inner surface side of the chassis member, the battery device includes a metal plate on one surface disposed to face the inner surface side of the chassis member, and the inner surface of the chassis member is provided with a conductive member that is in contact with the metal plate.

The above-described aspects of present invention can ensure grounding in the replaceable battery device.

### BRIEF DESCRIPTION OF THE DRAWINGS

FIG. 1 is an overall view of an electronic apparatus according to an embodiment.

FIG. 2 is a plan view schematically illustrating an internal structure of a chassis.

FIG. 3 is an exploded view showing an operation of attaching a battery device shown in FIG. 2 into the chassis.

FIG. 4 is a view of the battery device as viewed from a Z1 side.

FIG. 5 is a schematic sectional view taken along line V-V in FIG. 2.

FIG. 6 is a view showing an operation of attaching the battery device shown in FIG. 5 to a chassis member.

### DETAILED DESCRIPTION OF THE INVENTION

An electronic apparatus according to the present invention will be described in detail below with preferred embodiments with reference to the accompanying drawings.

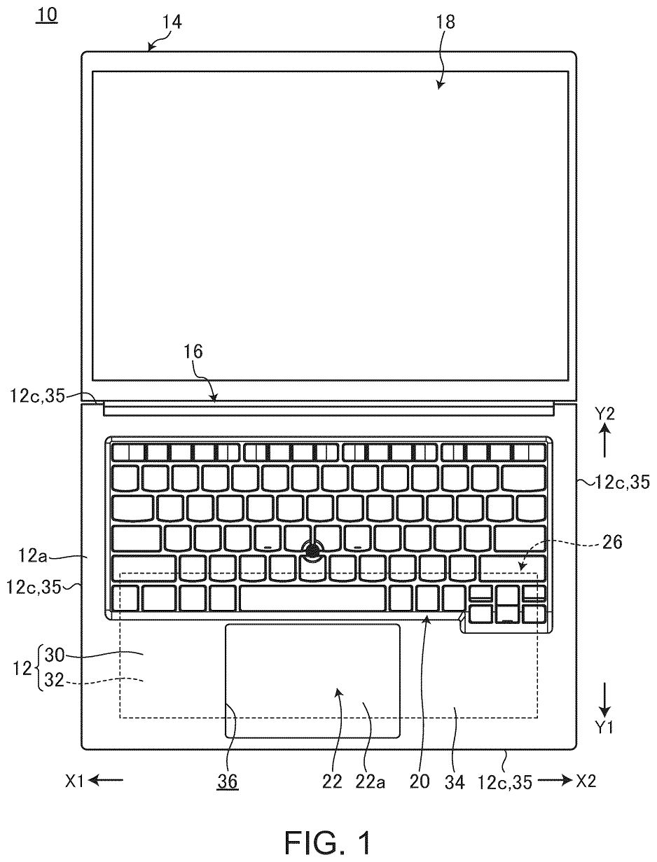

FIG. 1 is an overall view of an electronic apparatus 10 according to an embodiment. The electronic apparatus 10 is a clamshell-type notebook PC. The electronic apparatus 10 is configured such that a chassis 12 and a lid body 14 are connected to each other by a hinge 16 to be relatively rotatable. The electronic apparatus to which the present invention can be applied may be a tablet PC, a smartphone, a portable game machine, or the like, in addition to the notebook PC.

The lid body 14 has a flat box shape. A display 18 faces the front surface of the lid body 14. The display 18 is, for example, an organic EL display or a liquid crystal display. The lid body 14 is connected to a rear edge portion of the chassis 12 by the hinge 16.

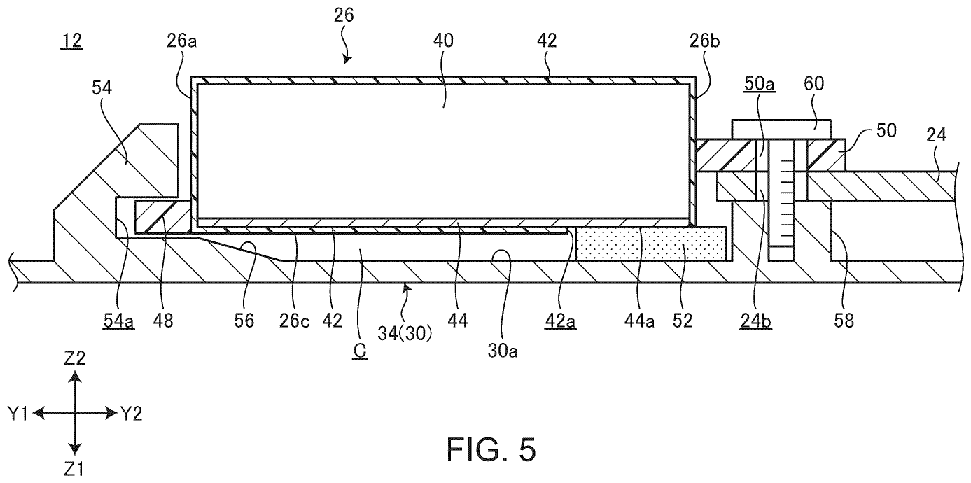

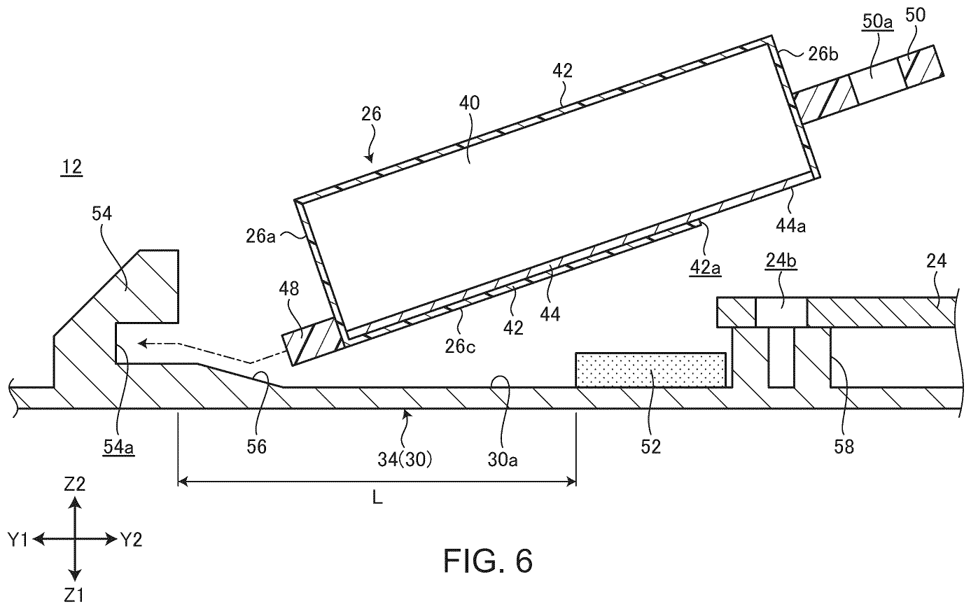

Hereinafter, the chassis 12 and each component mounted on the chassis 12 will be described by calling the left-right width direction of the chassis 12 as X1 and X2 directions, the front-rear depth direction as Y1 and Y2directions, and the up-down thickness direction as Z1 and Z2 directions. The X1 and X2 directions may be collectively referred to as the X direction, and the Y1 and Y2 directions and the Z1 and Z2 directions may be similarly referred to as the Y direction and the Z direction. In addition, for convenience of description, a keyboard 20 side (Z1 direction) in the thickness direction of the chassis 12 may be referred to as “down” and the opposite side (Z2 direction) may be referred to as “up” (refer to FIGS. 5 and 6). The names of these directions are for convenience of description, and the usage aspect of the electronic apparatus 10 is not limited thereto.

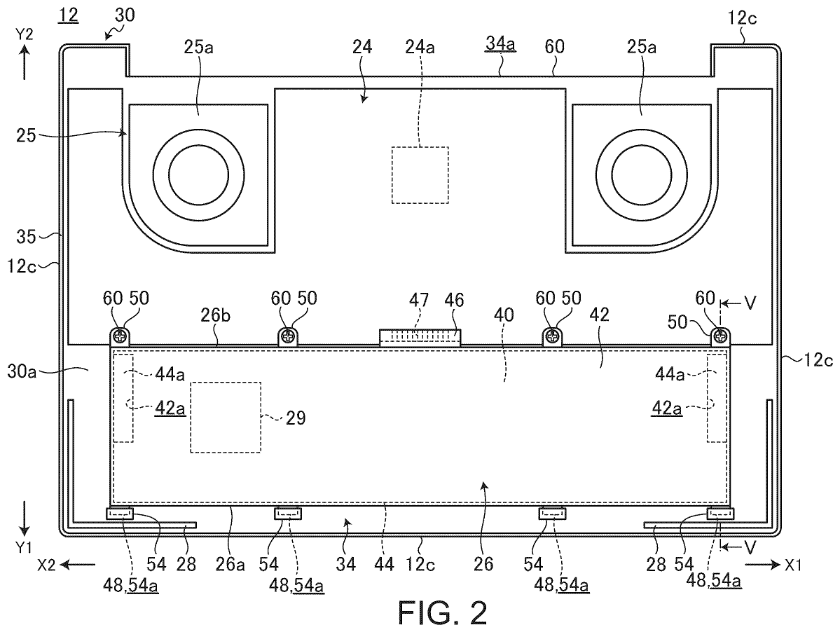

The chassis 12 is a flat box. A motherboard 24 on which a CPU 24a, a memory, and the like are mounted, and a cooling module 25 for cooling the CPU 24a and the like are housed inside the chassis 12 (refer to FIG. 2). A battery device 26, antenna elements 28 and 29, and the like, which are power sources of the electronic apparatus 10, are also housed inside the chassis 12.

The keyboard 20 and the touch pad 22 face a front surface 12a of the chassis 12. The keyboard 20 extends substantially over the entire width of the front surface 12a in the X direction. The keyboard 20 is installed in a wide range that extends from the vicinity of the Y2 side edge portion of the front surface 12a to the Y1 side from the center in the Y direction. The touch pad 22 has a rectangular shape in a plan view. The touch pad 22 is provided in the vicinity of the Y1 side edge portion of the front surface 12a and is disposed substantially in the center of the front surface 12a in the X direction. The touch pad 22 can operate a cursor (mouse pointer) displayed on the display 18 instead of a mouse. The touch pad 22 may be configured to perform a tracing operation of tracing an operation surface 22a with a fingertip or the like and a click operation of pressing the operation surface 22a with a fingertip or the like. The touch pad 22 may be configured to generate vibration by the actuator when a click operation is received.

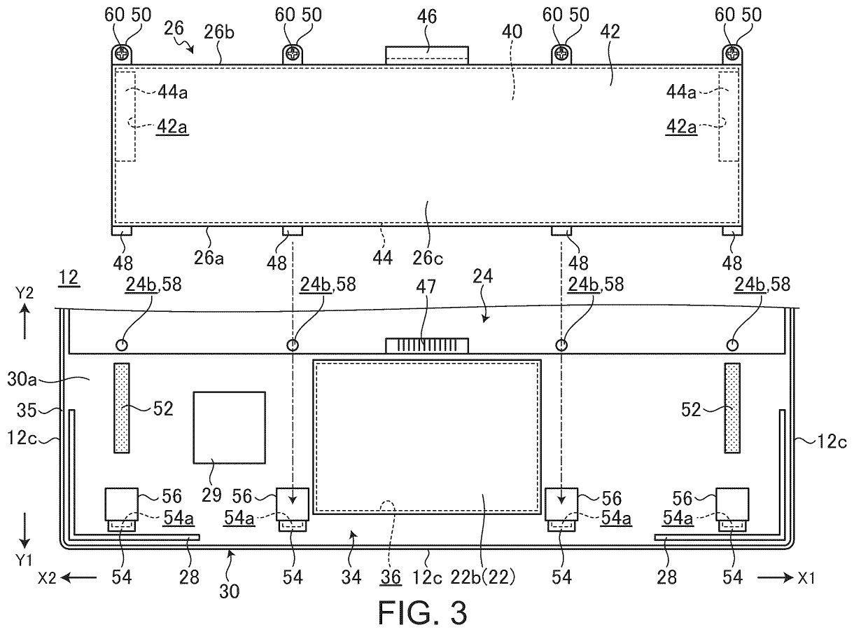

FIG. 2 is a plan view schematically illustrating an internal structure of the chassis 12. FIG. 3 is an exploded view showing an operation of attaching the battery device 26 shown in FIG. 2 into the chassis 12. FIGS. 2 and 3 are views showing the chassis 12 as viewed from the bottom surface side with the cover member 32 removed.

As shown in FIGS. 1 to 3, the chassis 12 includes a chassis member 30 and a cover member 32.

The chassis member 30 can have a plate portion 34 and a standing wall 35. The plate portion 34 is a plate-like member that forms a Z1-side surface (front surface 12a) of the chassis 12. The standing wall 35 stands up from the outer peripheral edge portion of the plate portion 34 in the Z2 direction. The standing wall 35 forms a part of the side surface 12c of the outer periphery of the chassis 12. As a result, the chassis member 30 has a shallow bathtub shape as a whole.

An opening portion 36 in which the touch pad 22 is installed is formed in the plate portion 34. The touch pad 22 is fixed to an inner surface 30a of the chassis member 30 (plate portion 34), and an operation surface 22a is exposed on the front surface 12a through the opening portion 36. That is, in the touch pad 22, a back surface 22b on a side opposite to the operation surface 22a is disposed on the inner surface 30a side and is exposed (refer to FIG. 3). A rectangular through-hole or a recessed portion on which the keyboard 20 is installed is also formed in the plate portion 34. A recessed hinge disposing portion 34a in which the hinge 16 is installed is formed on the Y2 side edge portion of the plate portion 34 (refer to FIG. 2).

The cover member 32 is a plate-like member that is attachably and detachably connected to the chassis member 30 and that opens and closes the Z2 side opening of the chassis member 30. The cover member 32 is connected to the chassis member 30 by, for example, an attachment/detachment mechanism using screws and hooks. Wall portions that form the side surfaces 12c are also formed on the four peripheral edge portions of the cover member 32 together with the standing wall 35. As a result, the cover member 32 also has a shallow bathtub shape as a whole.

As shown in FIGS. 2 and 3, the motherboard 24 is fixed to the inner surface 30a of the chassis member 30. The motherboard 24 is a circuit board that serves as a main board of the electronic apparatus 10. The motherboard 24 is disposed close to the Y2 side of the chassis 12 and extends in the X direction.

The cooling module 25 cools the CPU 24a and other components mounted on the motherboard 24. The cooling module 25 can have, for example, a pair of left and right fans 25a and 25a. The cooling module 25 can have a heat diffusion member or the like that absorbs and diffuses heat of the CPU 24a or the like between the left and right fans 25a and 25a.

The antenna elements 28 and 29 are fixed to the inner surface 30a of the chassis member 30 and are connected to a communication module mounted on the motherboard 24. The antenna element 28 is, for example, a wireless wide area network (WWAN) antenna. The antenna elements 28 are installed, for example, at left and right angular portions of the chassis member 30 on the Y1 side, and have an L-shape that surrounds each angular portion. The antenna element 29 is, for example, a Near Field Communication (NFC) antenna. The antenna element 29 is installed, for example, on the side portion on the X2 side of the touch pad 22.

The battery device 26 is a rechargeable battery that serves as a power source for the electronic apparatus 10. The battery device 26 can be configured of, for example, a lithium ion battery or a lithium polymer battery. The battery device 26 is disposed close to the Y1 side of the motherboard 24 and extends in the X direction.

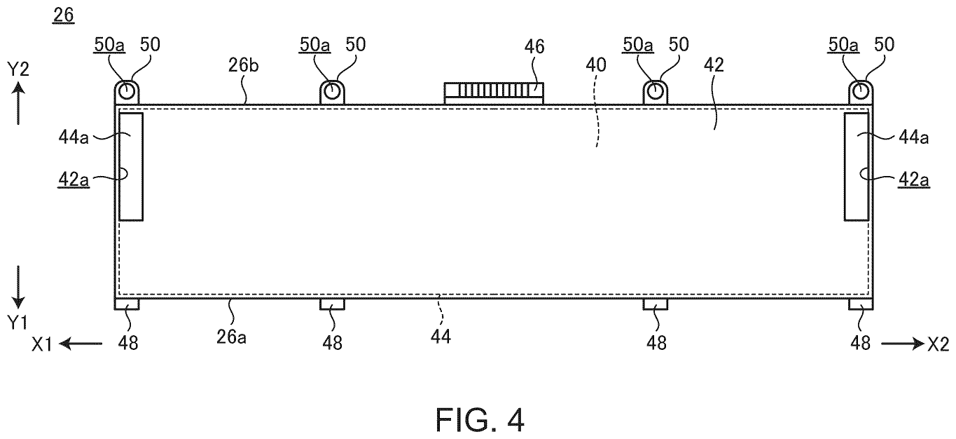

FIG. 4 is a view of the battery device 26 as viewed from the Z1 side. FIG. 5 is a schematic sectional view taken along line V-V in FIG. 2. FIG. 6 is a view showing an operation of attaching the battery device 26 shown in FIG. 5 to the chassis member 30.

As shown in FIGS. 2 to 5, the battery device 26 is attachably and detachably supported on the inner surface 30a side of the chassis member 30 and is covered with the cover member 32. The battery device 26 has, for example, a long total length in the X direction, a short width in the Y direction, and a flat rectangular parallelepiped shape in the Z direction. The battery device 26 has a size in which an edge portion (one edge portion) 26a on the Y1 side and an edge portion (the other edge portion) 26b on the opposite side thereof extend over most of the entire width of the chassis 12 in the X direction.

The battery device 26 can have a cell 40, a sheet material 42, a metal plate 44, a connector 46, a hook portion 48, and a screwing portion 50.

The battery device 26 has a configuration in which a plurality of cells 40 connected to each other are provided and a periphery of the cell 40 is wrapped with the sheet material 42. The sheet material 42 is a thin resin sheet having insulating properties. As the resin material forming the sheet material 42, for example, polycarbonate (PC) or polyethylene terephthalate (PET) can be used. The sheet material 42 is, for example, a front surface material that displays a model number, a standard, characteristics, and the like of the battery device 26.

The metal plate 44 is a thin metal plate member formed of, for example, stainless steel (SUS), steel, or the like. The plate thickness of the metal plate 44 is, for example, about 0.2 mm to 0.5 mm. The battery device 26 is assumed to be replaced by a user. The metal plate 44 is a protective member for protecting the battery device 26 during replacement or the like.

The metal plate 44 is provided on one surface (Z1 side surface) 26c of the battery device 26 that is disposed to face the inner surface 30a of the chassis member 30. The metal plate 44 can be provided to have substantially the same outer shape as the one surface 26c and to cover substantially the entire one surface 26c. The metal plate 44 increases the rigidity of the battery device 26. The metal plate 44 also suppresses the cell 40 from being locally compressed in a case where a foreign substance is sandwiched between the inner surface 30a and the surface 26c in a case of replacing the battery device 26.

As shown in FIGS. 4 and 5, the metal plate 44 of the present embodiment can be covered and hidden inside the sheet material 42. That is, the sheet material 42 wraps the cell 40 from above the metal plate 44. Accordingly, the battery device 26 employs a structure in which the metal plate 44 is not exposed on the one surface 26c.

A cutout hole 42a can be provided in a part of the sheet material 42. The cutout hole 42a is an opening that exposes a part (ground portion 44a) of the metal plate 44 to the one surface 26c. The ground portion 44a is used to frame ground the metal plate 44 and is located at a position where the ground portion 44a can be brought into contact with a conductive member 52 described later. The cutout hole 42a of the present embodiment is provided near both left and right ends in the longitudinal direction (X direction) of the battery device 26, and is provided at a position close to the edge portion 26b in the lateral direction (Y direction). The cutout hole 42a can be formed in, for example, a strip shape that is long in the Y direction. The cutout hole 42a and the ground portion 44a are preferably located at a position sandwiched between the screwing portion 50 and the hook portion 48 in the Y direction.

The metal plate 44 may be attached onto the sheet material 42 and left exposed. However, in this case, the metal plate 44 is exposed on substantially the entire surface of the one surface 26c of the battery device 26. Therefore, it is necessary to consider a short circuit, damage, and the like due to the contact with other components in a case of handling the battery device 26. Therefore, it is preferable that the metal plate 44 is covered with the sheet material 42 and only the ground portion 44a is exposed to the cutout hole 42a.

The connector 46 is a contact point that electrically connects the battery device 26 and the power source component mounted on the motherboard 24. The connector 46 is provided, for example, near the center of the edge portion 26b and protrudes in the Y2 direction. As shown in FIG. 3, a terminal 47 to which the connector 46 is connected is mounted on the motherboard 24. The connector 46 can be attachably and detachably connected to the terminal 47 in the Z direction. The connector 46 can be configured with, for example, a connector having a comb tooth structure in which a plurality of comb teeth are arranged in the X direction. The comb teeth are arranged in parallel in the X direction through slits at predetermined intervals, and terminals (contact points) that come into contact with the terminals 47 are provided therebetween. Accordingly, the connector 46 can be connected to the terminal 47 in the Z1 direction and can be removed from the terminal 47 in the Z2 direction.

The hook portion 48 and the screwing portion 50 constitute an attachment/detachment mechanism for attachably and detachably supporting the battery device 26 to and from the chassis member 30.

The hook portion 48 can be configured with a small plate piece that protrudes in the Y1 direction from the edge portion 26a of the battery device 26 on the Y1 side. A plurality of hook portions 48 are provided to be arranged along the edge portion 26a. In the present embodiment, four hook portions 48 are provided. The hook portion 48 can be engaged with and removed from an engaging hole 54a, which will be described later, provided on the inner surface 30a of the chassis member 30. Accordingly, the hook portion 48 holds the battery device 26 with respect to the chassis member 30 and prevents the battery device 26 from rattling in the X and Z directions.

The screwing portion (fastening portion) 50 can be configured with a small tongue-shaped plate piece protruding from the edge portion 26b of the battery device 26 on the Y2 side in the Y2 direction. A plurality of screwing portions 50 are provided to be arranged along the edge portion 26b. In the present embodiment, four screwing portions 50 are provided. The respective screwing portions 50 can be arranged in the Y direction with the respective hook portions 48. The screwing portion 50 can be fastened to a boss portion 58, which will be described later, provided on the inner surface 30a of the chassis member 30 with the motherboard 24 by a screw 60. Accordingly, the screwing portion 50 can fix the battery device 26 to the chassis member 30.

As shown in FIGS. 2 and 3, a conductive member 52, an engaged portion 54 in which the engaging hole 54a is formed, an inclined portion 56, and a boss portion 58 can be provided on the inner surface 30a of the chassis member 30. These are present in a part covered with the battery device 26 and a peripheral portion thereof.

The conductive member 52 can be formed of a cushioning material such as a sponge having conductivity. The conductive member 52 of the present embodiment is a conductive gasket. The conductive member 52 is fixed to the inner surface 30a with a double-sided adhesive tape or the like. The conductive member 52 comes into contact with the metal plate 44 to ground (frame ground) the metal plate 44 with respect to the chassis member 30.

In the present embodiment, the conductive member 52 comes into contact with the ground portion 44a of the metal plate 44 through the cutout hole 42a. Therefore, a pair of left and right conductive members 52 is provided to vertically overlap with the pair of left and right ground portions 44a. That is, the conductive member 52 is provided at a position closer to the edge portion 26b side than the edge portion 26a with reference to the position of the inner surface 30a with respect to the battery device 26 in a plan view. Specifically, the conductive member 52 is located at a position separated from the opening end (Y2 side end) of the engaging hole 54a by a distance L in the Y2 direction (refer to FIG. 6). The conductive member 52 is located at a position sandwiched between the screwing portion 50 and the hook portion 48 in the Y direction. Each conductive member 52 can have a shape that matches the shape of each cutout hole 42a (ground portion 44a), for example, a rod shape that is long in the Y direction.

The disposition and shape of the conductive member 52 and the ground portion 44a are not limited to the above. However, it is preferable that the conductive member 52 is provided at a position that does not vertically overlap with the touch pad 22. The reason for this is to prevent the touch pad 22 from being loaded by the repulsive force of the conductive member 52 pressed against the ground portion 44a and to prevent the touch operability from being affected.

The engaged portion 54 is a receiving portion for disengaging the hook portion 48, and the number of engaged portions 54 is the same as the number of hook portions 48. The engaged portion 54 can have a shape in which the engaged portion 54 stands up from the inner surface 30a to the Z2 side and the engaging hole 54a is open on a side surface facing the Y2 side. That is, the engaged portion 54 can have a hook shape that protrudes from the inner surface 30a and faces the Y2 side to be engageable with the hook portion 48. Each engaged portion 54 is provided to be arranged along the Y1 side edge portion of the inner surface 30a and faces each hook portion 48.

The inclined portion 56 is formed on the inner surface 30a and forms an inclined surface that is inclined to the Z2 side from the Y1 side. The inclined portion 56 is provided immediately before each engaged portion 54 (Y2 side). As shown in FIG. 5, the battery device 26 has a gap C in the Z direction between the one surface 26c and the inner surface 30a in a state of being attached to the chassis member 30. The gap C is a gap for avoiding interference with each component or uneven shape provided on the inner surface 30a, and is also an installation space for the conductive member 52. Therefore, the engaging hole 54a is disposed at a position that is raised from the inner surface 30a (Z2 side). The inclined portion 56 forms a guide surface for easily engaging the hook portion 48 with the engaging hole 54a at a position that is raised from the inner surface 30a in this manner. The inclined portion 56 may be omitted.

The boss portion 58 is a part for fastening the screwing portion 50, and the number of the boss portions 58 is the same as the number of the screwing portions 50. The boss portion 58 is a small-diameter cylindrical portion provided to stand up from the inner surface 30a to the Z2 side, and a female screw hole is formed at the axial center thereof. Each boss portion 58 is provided to be arranged along the edge portion 26b of the battery device 26 on the Y2 side and vertically overlaps with each screwing portion 50. A screw 60 that passed through a hole portion 50a formed in the screwing portion 50 is fastened to the boss portion 58. In the case of the present embodiment, the motherboard 24 is sandwiched between the screwing portion 50 and the boss portion 58. That is, the screw 60 can fasten the motherboard 24 and the screwing portion 50 to the chassis member 30. A hole portion 24b, which communicates with the hole portion 50a and through which the screw 60 passes, is formed in the motherboard 24.

Next, the replacement operation of the battery device 26 will be described.

First, a procedure for removing the battery device 26 will be described. In a case of removing the battery device 26, the lid body 14 is closed on the front surface 12a of the chassis 12, and the electronic apparatus 10 is placed on a desk surface or the like with the bottom surface 12b side of the chassis 12 facing upward. The cover member 32 is removed from the chassis member 30. As a result, the battery device 26 can be accessed (refer to FIGS. 2 and 5).

Subsequently, after removing each screw 60, the battery device 26 is gripped near the edge portion 26b and lifted up (to the Z2 side). In this case, since the connector 46 is attachably and detachably connected to the terminal 47 in the Z direction, the connector 46 is easily disengaged from the terminal 47. Therefore, the battery device 26 is moved obliquely upward to the Y2 side. Accordingly, the hook portion 48 is pulled out from the engaging hole 54a, and the battery device 26 can be easily removed from the chassis member 30.

Next, a procedure of attaching a new battery device 26 to be replaced instead of the battery device 26 removed as described above will be described.

As shown in FIG. 6, the battery device 26 is in an inclined posture in which the edge portion 26b is lifted upward and the hook portion 48 is directed downward. Subsequently, the hook portion 48 is pushed into the engaging hole 54a. In this case, since the inclined portion 56 is provided in front of the engaging hole 54a, the hook portion 48 can be smoothly engaged with the engaging hole 54a along the inclined portion 56.

In this case, the conductive member 52 is at a position separated from the engaging hole 54a by a distance L on the Y2 side (refer to FIG. 6). Therefore, the hook portion 48 is prevented from being caught by the conductive member 52 in a case of being engaged with the engaging hole 54a along the inner surface 30a. As a result, it is possible to prevent the hook portion 48 from unintentionally peeling off the conductive member 52. Therefore, the distance L is preferably at least equal to or greater than the engagement distance (insertion distance) between the hook portion 48 and the engaging hole 54a. More preferably, in a case where the distance L is, for example, 2 times or more the engagement distance, the interference between the hook portion 48 and the conductive member 52 can be more reliably prevented. The distance L can also be set to be longer than at least the Y direction distance of the inclined portion 56. The distance L is also effective in preventing the conductive member 52 from being peeled off in a case where the hook portion 48 is pulled out from the engaging hole 54a.

Subsequently, the edge portion 26b is lowered. In this case, the screwing portion 50 is placed on the motherboard 24, and the hole portion 50a overlaps with the hole portion 24b. In this case, the conductive member 52 comes into contact with the ground portion 44a of the metal plate 44 through the cutout hole 42a. Since the connector 46 is attachable and detachable to and from the terminal 47 in the Z direction, the connector 46 is smoothly connected to the terminal 47.

The screw 60 is fastened to the boss portion 58 through the hole portions 50a and 24b (refer to FIG. 5). As a result, the battery device 26 is attached to the chassis member 30, and the conductive member 52 is pressed against the ground portion 44a. Finally, the cover member 32 is connected to the chassis member 30, and thus the attachment work of the battery device 26 is completed.

As described above, the electronic apparatus 10 of the present embodiment includes the battery device 26 that is attachably and detachably supported on the inner surface 30a side of the chassis member 30. The battery device 26 has the metal plate 44 on one surface 26c disposed to face the inner surface 30a side of the chassis member 30. The conductive member 52 that comes into contact with the metal plate 44 is provided on the inner surface 30a of the chassis member 30.

As described above, the electronic apparatus 10 includes the metal plate 44 on one surface 26c of the battery device 26. As a result, the replaceable battery device 26 can be protected. In this case, the metal plate 44 comes into contact with the conductive member 52 in a state where the battery device 26 is attached to the chassis member 30, and is frame-grounded. As a result, it is possible to prevent the metal plate 44, which is a conductor having a large area, from being in an electrically raising state in the chassis 12. As a result, for example, it is possible to suppress the influence of noise or the like on the antenna elements 28 and 29 installed around the battery device 26.

The battery device 26 can have the insulating sheet material 42 that covers at least one surface 26c from above the metal plate 44. The cutout hole 42a through which the metal plate 44 is exposed to the outside can be provided in a part of the sheet material 42. In this case, it is possible to prevent the metal plate 44 from being exposed and installed on the outer surface of the battery device 26. Moreover, the conductive member 52 can be reliably electrically brought into contact with the metal plate 44 through the cutout hole 42a.

In a plan view of the inner surface 30a of the chassis member 30, the conductive member 52 can be at a position sandwiched between the screwing portion 50 and the hook portion 48. As a result, the conductive member 52 and the metal plate 44 can be more reliably brought into contact with each other. In addition, for example, a repulsive force from the conductive member 52 formed of a conductive gasket can be reliably received by the screwing portion 50 and the hook portion 48, and a load on the cell 40 and the like can be suppressed.

The present invention is not limited to the above-described embodiment, and it goes without saying that the present invention can be freely modified without departing from the gist of the present invention.

1. An electronic apparatus, comprising:
a chassis member having an inner surface;
a battery device that is attachably and detachably supported on an inner surface side of the chassis member,
wherein the battery device includes a metal plate on one surface disposed to face the inner surface side of the chassis member, and
the inner surface of the chassis member has a conductive member thereon and that is configured to contact the metal plate.

2. The electronic apparatus according to claim 1,
wherein the battery device includes an insulating sheet material that covers at least the one surface at the metal plate,
a cutout hole that exposes the metal plate is in a part of the insulating sheet material, and
the conductive member is configured to contact the metal plate through the cutout hole.

3. The electronic apparatus according to claim 1,
wherein the battery device includes a hook portion that protrudes from one edge portion of the battery device,
an engaging hole configured to engage with the hook portion and is on the inner surface of the chassis member, and
in a plan view of the inner surface of the chassis member, the conductive member is adjacent to another edge portion side opposite to the one edge portion of the battery device.

4. The electronic apparatus according to claim 3,
wherein the battery device includes a screwing portion on the other edge portion side, and
in the plan view of the inner surface of the chassis member, the conductive member is configured to be sandwiched between the screwing portion and the hook portion.

5. The electronic apparatus according to claim 1, further comprising:
a touch pad that is supported by the chassis member and is disposed at a position vertically overlapping with a part of the battery device,
wherein the conductive member is at a position that does not vertically overlap with the touch pad.
